(19) United States
(12) Patent Application Publication
(10) Pub. No.: US 2016/0185161 A1
(43) Pub. Date: Jun. 30, 2016

(54) PNEUMATIC TIRE AND MOLDING DIE THEREOF

(71) Applicant: TOYO TIRE & RUBBER CO., LTD., Osaka (JP)

(72) Inventor: Shinichi Kaji, Osaka-shi (JP)

(73) Assignee: TOYO TIRE & RUBBER CO., LTD., Osaka (JP)

(21) Appl. No.: 14/972,240

(22) Filed: Dec. 17, 2015

(30) Foreign Application Priority Data
Dec. 25, 2014 (JP) 2014-262724

(51) Int. Cl. B60C 11/03; B29C 33/42; B29D 30/68; B60C 11/12

(52) U.S. Cl. CPC B60C 11/0327; B60C 11/1204; B60C 11/1272; B29C 33/42; B29D 30/68; B60C 2011/0334; B29K 2995/0073

(57) ABSTRACT

A sipe is provided to a land portion provided to a tread of a pneumatic tire. The sipe includes a slit having a width of 0.6 mm or less. The slit has an arithmetic surface roughness Ra of 1.6 μm or less on a pair of opposing wall surfaces. A molding die of a pneumatic tire includes a sipe plate to shape a sipe. The sipe plate includes a thin plate having a thickness of 0.6 mm or less. The thin plate has an arithmetic mean roughness Ra of 1.8 μm or less on a pair of side surfaces. Owing to this configuration, deformation of a land portion when making contact with the ground is suppressed regardless of a sipe provided to the land portion.

### CROSS-REFERENCE TO RELATED APPLICATIONS

This application is based upon and claims the benefit of priority from the prior Japanese Patent Application No. 2014-262724, filed on Dec. 25, 2014; the entire contents of which are incorporated herein by reference.

### BACKGROUND

1. Technical Field

The present invention relates to a pneumatic tire and a molding die thereof.

2. Related Art

Snow tires (studless tires), for example, have incisions called sipes which are made in land portions, such as blocks and ribs. An edge effect by the sipes enables stable running on a road surface covered with snow and ice where a frictional coefficient is low. Whereas the sipes obtain the effect as above, as is shown in FIG. 9, a sipe 101 lowers rigidity of a land portion 102 and the land portion 102 undergoes deformation (collapses) to a greater extent when making contact with the ground. Such deformation may possibly reduce the edge effect contrary to the intention, or lower resistance to irregular wear. In order to suppress deformation of the land portions, sipes of a shape changed in a depth direction, so-called three-dimensional sipes, have been proposed. In the case of the three-dimensional sipes, however, resistance of a sipe plate is large when pulled out from a surface of tread rubber at the time of die releasing of a tire (that is, when a tire molded by vulcanization is released from the molding die), and large resistance may possibly cause a defect in the rubber.

JP-A-8-175115 discloses that deformation of land portions is suppressed by providing 20 to 300 μm irregularities to a pair of opposing wall surfaces of a sipe with the aim of increasing frictional resistance between a pair of the wall surfaces. Also, JP-T-2005-505456 (a published Japanese translation of WO2003/033281) discloses that an engaging effect between a pair of wall surfaces of a sipe is enhanced by providing ribs called a relief in the form of a diagonally inclined grating to the wall surfaces, by forming the entire wall surfaces with a mean roughness of 1/100 to 1/10 of a sipe width, and by combining a macro-level roughness and a micro-level roughness. However, by roughening the wall surfaces of a sipe as these methods, a deformation suppressing effect on the land portions is not necessarily satisfactory.

JP-A-8-258515 discloses that 50 to 200 μm irregularities are provided to the wall surfaces of a sipe with the aim of suppressing collapse of a block due to adhesion between the wall surfaces of a sipe when the sipe plate is pulled out from the surface of tread rubber at the time of die releasing of a tire. However, as with JP-A-8-175115, the disclosed method is also to roughen the wall surfaces of a sipe. Hence, the deformation suppressing effect on the land portions when the tire makes contact with the ground is not satisfactory.

Meanwhile, JP-A-11-42913 discloses to set a width of a sipe to 0.1 to 0.3 mm, which is narrower than a typical width, and to provide a pillar-like space extending in a sipe depth direction to reinforce the sipe plate with the aim of enhancing braking performance on ice. JP-A-11-42913, however, is silent about making the wall surfaces of a sipe to a mirror-smooth state.

A width of a typical sipe in the related art is about 0.6 to 1.5 mm and relatively wide. Also, after the sipe plate used to shape a sipe is attached to a die surface, sand blasting is generally applied to a tire molding die in order to make the entire die surface smooth. Even when surfaces of the sipe plate are mirror surfaces before the attachment to the die surface, it is unavoidable for the surfaces to be roughened to a certain degree by sand blasting. Consequently, the wall surfaces of a sipe shaped by the sipe plate in the related art may appear to be flat, but actually have an arithmetic mean roughness Ra of 2.5 μm or greater. A relatively wide sipe having rough surfaces on the wall surfaces as above cannot suppress deformation of the land portions when the tire makes contact with the ground.

### SUMMARY

In view of the foregoing, embodiments of the invention have an object to provide a pneumatic tire capable of suppressing deformation of land portions when making contact with the ground regardless of sipes provided to the land portions, and a molding die thereof.

The inventor discovered that the above object can be achieved by making wall surfaces of a sipe smoother as means for suppressing deformation of land portions when the tire makes contact with the ground, which is a technique totally different from the technique in the related art according to which the wall surfaces of a sipe are allowed to engage with each other by providing irregularities to the wall surfaces.

A first embodiment relates to a pneumatic tire which includes a land portion provided to a tread, and a sipe provided to the land portion. The sipe includes a slit having a width of 0.6 mm or less, and the slit has an arithmetic mean roughness Ra of 1.6 μm or less on a pair of opposing wall surfaces.

A second embodiment relates to a pneumatic tire which includes a land portion provided to a tread, and a sipe provided to the land portion. The sipe has a pair of opposing wall surfaces having surface smoothness and an interval that allow the wall surfaces to attract each other by a water film made of water entering into a space between the opposing wall surfaces.

A third embodiment relates to a molding die of a pneumatic tire, which includes a sipe plate to shape a sipe in a land portion provided to a tread. The sipe plate includes a thin plate having a thickness of 0.6 mm or less, and the thin plate has an arithmetic mean roughness Ra of 1.8 μm or less on a pair of side surfaces that shape a pair of opposing wall surfaces of the sipe.

According to the embodiments above, when a tire makes contact with a road surface containing moisture, such as a road surface covered with snow and ice, water is trapped inside the sipe and the wall surfaces readily attract or adhere to each other. Hence, deformation of the land portion when making contact with the ground can be suppressed.

### BRIEF DESCRIPTION OF THE DRAWINGS

FIG. 1 is a developed view showing a tread pattern of a pneumatic tire according to a first embodiment;

FIG. 2 is a plan view of a block of the first embodiment with an inset showing a partially enlarged view;

FIG. 3A is a sectional view taken along the line IIIa-IIIa of FIG. 2 and FIG. 3B is a sectional view taken along the line IIIb-Mb of FIG. 2;

FIG. 4 is an enlarged perspective view of a major portion of a tire molding die to show a sipe plate according to the first embodiment;

FIG. 5 is an enlarged sectional view of the block of the first embodiment to show a state when a tire makes contact with the ground;

FIG. 6 is a plan view of a block according to a second embodiment with an inset showing a partially enlarged view;

FIG. 7A is a sectional view taken along the line VIIa-VIIa of FIG. 6 and FIG. 7B is a sectional view taken along the line VIIb-VIIb of FIG. 6;

FIG. 8 is an enlarged perspective view of a major portion of a tire molding die to show a sipe plate according to the second embodiment;

FIG. 9 is a sectional view of a block in the related art to show a state when a tire makes contact with the ground; and

FIG. 10 is a schematic view showing an amount of step-like wear in evaluation of resistance to irregular wear.

### DETAILED DESCRIPTION

Hereinafter, embodiments of the invention will be described according to the drawings.

### First Embodiment

A pneumatic tire according to a first embodiment is formed of a pair of bead portions and side wall portions on the right and left, and a tread portion 10 provided between the side wall portions on the right and left so as to connect the both side wall portions along outer edges in a radial direction, but the illustration is omitted herein. The pneumatic tire can adopt a typical tire structure except for a tread pattern.

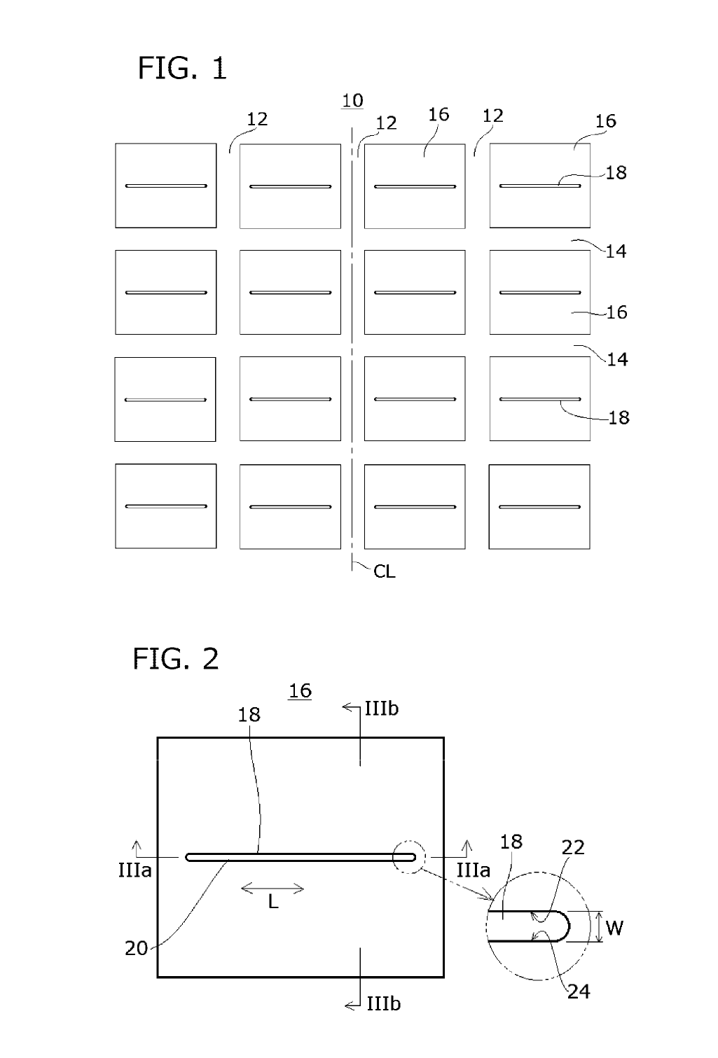

As is shown in FIG. 1, a plurality of main grooves (grooves in a circumferential direction) 12 extending in a tire circumferential direction and a plurality of traverse grooves (grooves in a width direction) 14 extending in a direction (tire width direction) intersecting with the main grooves 12 are provided to a surface of the tread portion 10. The main grooves 12 and the traverse grooves 14 together define blocks 16 as a plurality of land portions. Each block 16 is provided with a sipe 18 extending in a direction intersecting with the tire circumferential direction. Herein, the sipe 18 is an incision that does not open to a block edge at both ends (that is, an incision that terminates within the block 16 without opening to the main grooves 12, and is therefore referred to also as a closed sipe). In FIG. 1, CL denotes a tire equator.

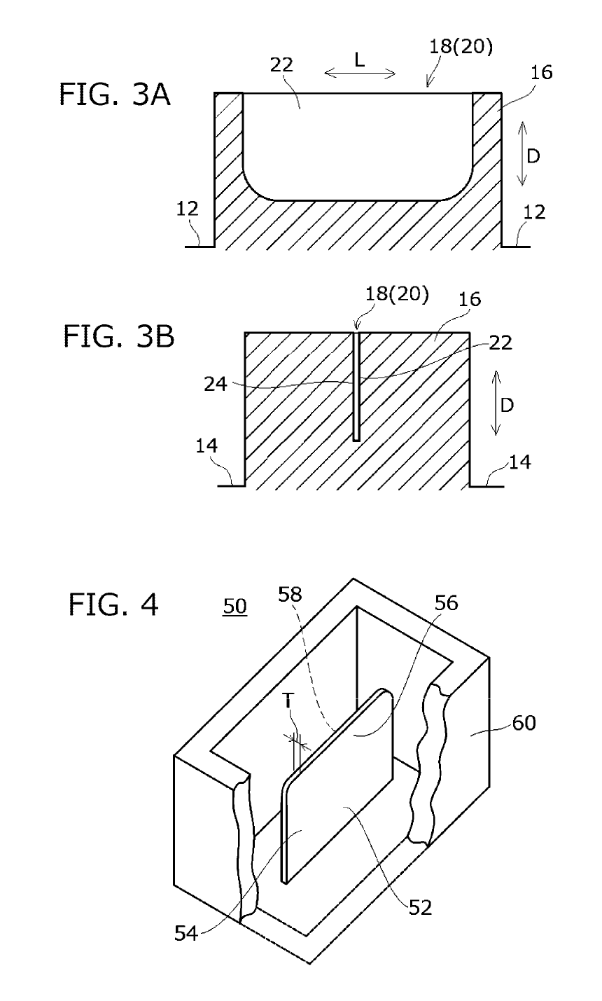

As is shown in FIG. 2 in enlargement, the sipe 18 is a linear sipe extending parallel to the tire width direction and one sipe 18 is provided to each block 16. Also, as is shown in FIG. 3B, the sipe 18 is of a linear shape that extends in a tire radial direction in cross section across the width, in a sipe depth direction D. The sipe 18 is formed in a constant width W both in a sipe length direction L and the sipe depth direction D. Two or more sipes 18 spaced apart in the tire circumferential direction may be provided to each block 16. Alternatively, the sipe 18 may extend at an angle with respect to the tire width direction. Further, the sipe 18 is not limited to the linear sipe when viewed in a plane as shown in FIG. 2, and may be a wave-like sipe (that is, a sipe having a wave-like opening) when viewed in a plane.

In this embodiment, the sipe 18 includes a slit (that is, a narrow portion) 20 having a width W of 0.6 mm or less. The slit 20 has an arithmetic mean roughness Ra set to 1.6 μm or less on a pair of opposing wall surfaces 22 and 24. In other words, the sipe 18 has a pair of the opposing wall surfaces 22 and 24 having a surface arithmetic mean roughness Ra of 1.6 μm or less and an interval W of 0.6 mm or less. Herein, the entire sipe 18 is formed as the slit 20. In other words, the sipe 18 essentially consists of the slit 20. Hence, the width W is set to 0.6 mm or less and an arithmetic mean roughness Ra on a pair of the opposing wall surfaces 22 and 24 is set to 1.6 μm or less anywhere in the sipe 18. As with the sipe 18, the slit 20 is not limited to the linear slit when viewed in a plane, and may be a wave-like slit when viewed in a plane.

The width (that is, an interval between a pair of the wall surfaces 22 and 24) W of the sipe 18 (the slit 20) is preferably 0.4 mm or less, and more preferably 0.3 mm or less. The smaller a value of the width W becomes, the greater will be an attraction effect by water trapped inside the sipe 18. Accordingly, the width W has no particular lower limit and may be, for example, 0.1 mm or greater.

Both of the opposing wall surfaces (groove wall surfaces) 22 and 24 of the sipe 18 (the slit 20) have a surface arithmetic mean roughness Ra of 1.6 μm or less as described above and are made smooth or made into a mirror-smooth state in comparison with typical sipe wall surfaces in the related art. The arithmetic mean roughness Ra on the wall surfaces 22 and 24 is preferably 1.3 μm or less, and more preferably 1.0 μm or less. The smaller a value of the arithmetic mean roughness Ra becomes, the smoother are the wall surfaces 22 and 24 and the greater will be the attraction effect by water trapped inside the sipe 18. Accordingly, the arithmetic mean roughness Ra has no particular lower limit, and may be, for example, 0.1 μm or greater, or 0.5 μm or greater. Herein, the arithmetic mean roughness Ra is defined according to JIS B0601:2013. More specifically, the arithmetic mean roughness Ra is a value obtained by extracting a reference length alone from a roughness curve in a direction of a mean line, adding up an absolute value of a deviation from the mean line to a measured curve of the extracted portion, and computing an average of a total.

FIG. 4 shows a major portion of a tire molding die (molding metal die) 50 provided with a sipe plate 52 which is a metal plate to shape the sipe 18 in the block 16. In FIG. 4, numeral 60 denotes a rib to shape the main grooves 12 and the traverse grooves 14, which is shown schematically in a partially cut-out state.

The sipe plate 52 includes a thin plate (that is, a thin plate portion) 54 having a thickness T of 0.6 mm or less. The thin plate 54 has an arithmetic mean roughness Ra set to 1.8 μm or less on a pair of side surfaces 56 and 58 that shape a pair of the opposing wall surfaces 22 and 24 of the sipe 18. Herein, the entire sipe plate 52 is formed as the thin plate 54. In other words, the sipe plate 52 essentially consists of the thin plate 54. Accordingly, the sipe plate 52 is shaped like a flat plate having the thickness T of 0.6 mm or less and the arithmetic mean roughness Ra of 1.8 μm or less on both of the two side surfaces 56 and 58 at any point.

Generally, a surface roughness on the wall surfaces 22 and 24 of the sipe 18 transferred from the side surfaces 56 and 58 of the sipe plate 52 is smaller than a surface roughness on the side surfaces 56 and 58 of the sipe plate 52. Hence, by setting the arithmetic mean roughness Ra on the side surfaces 56 and 58 of the sipe plate 52 to 1.8 μm or less, the arithmetic mean roughness Ra on the wall surfaces 22 and 24 of the sipe 18 can be set to 1.6 μm or less. The arithmetic mean roughness Ra on the side surfaces 56 and 58 of the sipe plate 52 (the thin plate 54) is preferably 1.6 μm or less, and more preferably 1.3 μm or less. The lower limit may be, for example, 0.1 μm or greater, or 0.5 μm or greater.

As with the width W of the sipe 18, the thickness T of the sipe plate 52 (the thin plate 54) is preferably 0.4 mm or less, and more preferably 0.3 mm or less. The lower limit may be, for example, 0.1 mm or greater.

For configurations other than the sipe plate 52, the tire molding die 50 can adopt a structure of a typical tire molding die. In this embodiment, a plurality of the sipe plates 52 are planted in a die surface of the tire molding die 50 at positions corresponding to the sipes 18. The pneumatic tire as described above can be manufactured by subjecting an unvulcanized green tire to molding by vulcanization in an ordinary manner using the tire molding die 50. In a fabrication sequence of a tire molding die, it is general to apply sand blasting after the sipe plates are attached to the die surface in order to make the entire die surface smooth. Hence, surfaces of the side surfaces 56 and 58 of the sipe plates 52 are also roughened unless some measures are taken. For this reason, it may be configured in this embodiment in such a manner that sand blasting is applied while the side surfaces 56 and 58 of the sipe plates 52 are covered with a masking sheet and the masking sheet is removed after the sand blasting. Alternatively, it may be configured in such a manner that sand blasting is applied without using a masking sheet first and then the side surfaces 56 and 58 of the sipe plates 52 are polished so as to have the predetermined arithmetic mean roughness Ra.

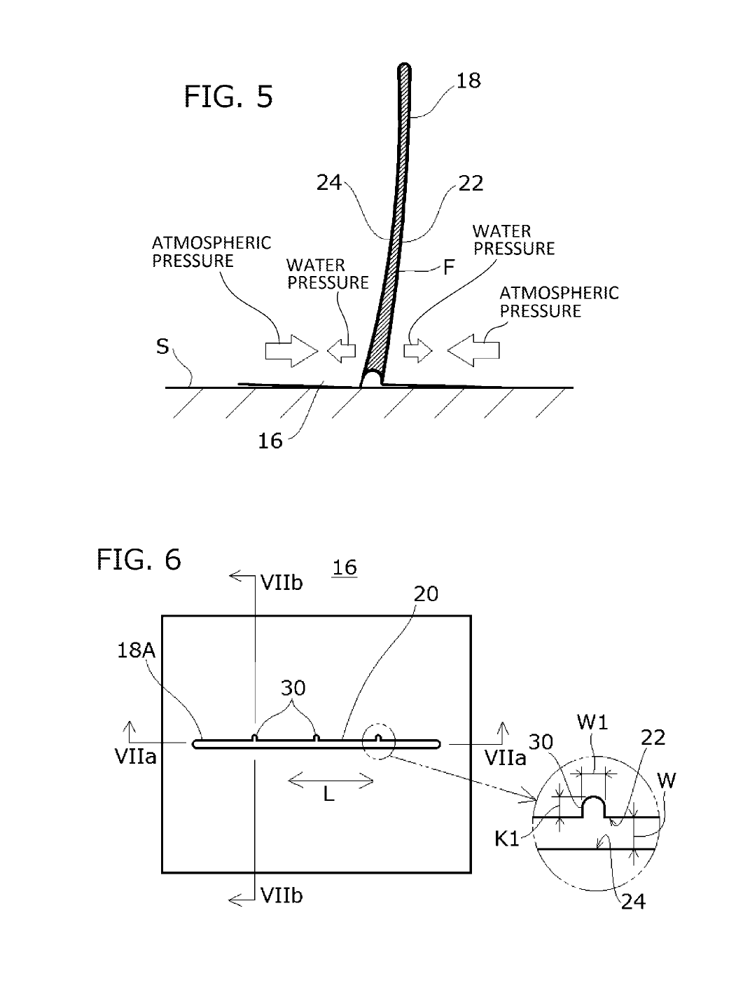

According to the pneumatic tire of this embodiment configured as above, water is trapped inside the sipe 18 as is shown in FIG. 5 when the block 16 makes contact with a road surface S containing moisture, such as a road surface covered with snow and ice, which allows the opposing wall surfaces 22 and 24 of the sipe 18 to adhere to each other. In other words, a pair of the opposing wall surfaces 22 and 24 of the sipe 18 has a narrow interval W and smooth surfaces without irregularities. Hence, the wall surfaces 22 and 24 are in an adhesion state via a water film F without having air remained in between. In this instance, an attraction effect or a pressure bonding effect is thought to be obtained by a difference of a water pressure and atmospheric pressure between the wall surfaces 22 and 24 as is shown in FIG. 5. Because the adhesion effect between the wall surfaces 22 and 24 can be obtained in this manner, rigidity of the blocks 16 can be increased. Accordingly, deformation of the blocks 16 when making contact with the ground can be suppressed regardless of the sipes 18 provided to the blocks 16. Hence, not only can resistance to irregular wear be enhanced, but also an edge effect can be exerted and therefore ice performance can be enhanced.

In view of the foregoing, a pair of the opposing wall surfaces 22 and 24 of the sipe 18 in this embodiment has surface smoothness Ra and an interval W which allow the wall surfaces 22 and 24 to attract each other by the water film F made of water entering into a space between the wall surfaces 22 and 24, that is to say, the wall surfaces 22 and 24 have a narrower width and higher smoothness than sipes in the related art. Consequently, an effect by which the wall surfaces 22 and 24 attract each other and form one unit is exerted, which can enhance rigidity of the blocks 16.

According to this embodiment, because the sipe plates 52 are smooth, resistance of the sipe plates 52 is small when pulled out from the surface of tread rubber at the time of mold releasing in the manufacturing of a tire and a defect of the rubber can be suppressed.

### Second Embodiment

Configurations of sipes and sipe plates according to a second embodiment will be described according to FIG. 6 through FIG. 8. A sipe 18A of the second embodiment is different from the counterpart in the first embodiment above in that at least one concave groove 30 extending in a sipe depth direction D is provided to at least one of a pair of opposing wall surfaces 22 and 24 of a slit 20.

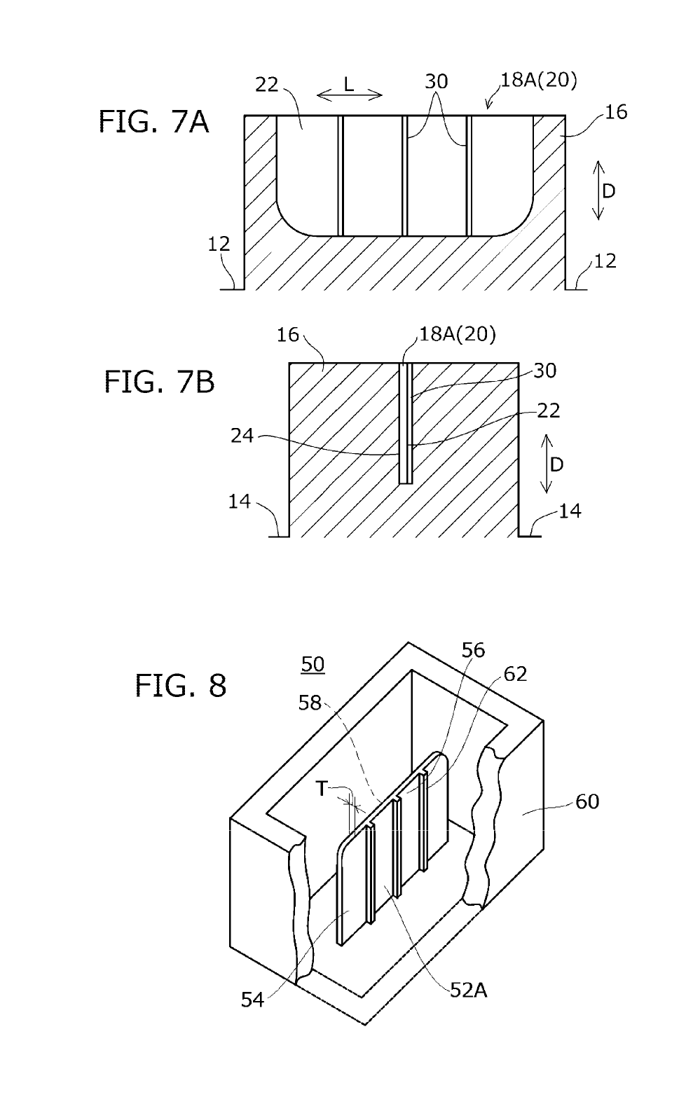

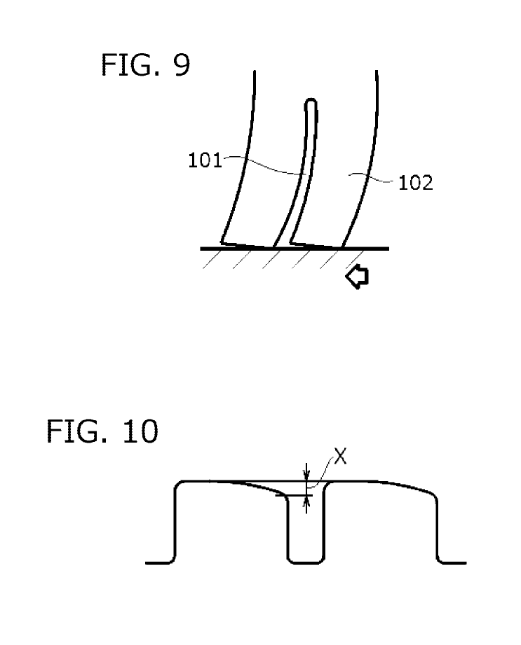

More specifically, the concave groove 30 is provided to one wall surface 22 alone herein, and three concave grooves 30 spaced apart (herein, equally spaced apart) in a sipe length direction L are provided to the one wall surface 22. The concave groove 30 is a fine groove having a width W1 (a dimension of the concave groove 30 in the sipe length direction L) equal to or less than a width W of the sipe 18A (W1≦W). A recess depth K1 of the concave groove 30 shown in FIG. 6 when viewed in a plane is set to be equal to or less than the width W of the sipe 18A (K1≦W). As are shown in FIG. 7A and FIG. 7B, the concave grooves 30 are provided to the sipe 18A fully in the sipe depth direction D and formed linearly from an opening surface to a bottom of the sipe 18A.

FIG. 8 shows a sipe plate 52A to shape the sipe 18A in a block 16. In order to shape the concave grooves 30, the sipe plate 52A is configured in such a manner that at least one convex ridge 62 extending in the sipe depth direction D is provided to at least one of a pair of side surfaces 56 and 58 of the sipe plate 52A (more specifically, the thin plate 54). Herein, the convex ridge 62 is provided to one side surface 56 alone, and three convex ridges 62 spaced apart in the sipe length direction L are provided to the one side surface 56. As with the shape of the concave groove 30, a shape of the convex ridge 62 has a width equal to or less than a thickness T of the sipe plate 52A, and a protrusion height when viewed in a cross section is set to be equal to or less than the thickness T. The convex ridges 62 are provided to the sipe plate 52A fully in a height direction, and formed linearly from a root to a tip end of the sipe plate 52A.

Other configurations of the second embodiment including the width W and smoothness of the wall surfaces 22 and 24 of the sipe 18A as well as the thickness T and smoothness of the side surfaces 56 and 58 of the sipe plate 52A are the same as the configurations of the first embodiment above, and a description is omitted herein.

According to the second embodiment, in addition to the function and the effect obtained in the first embodiment above, a function and an effect as follows can be obtained. That is, by providing the concave grooves 30 to the wall surface 22 of the sipe 18A, introduction of water into the sipe 18A can be accelerated. The concave grooves 30 thus serve to draw water into the sipe 18A and an adhesion action between the wall surfaces 22 and 24 described above can be exerted at an early stage by providing the concave grooves 30.

### Other Embodiments

In the embodiments above, the slit 20 having a narrow width and smoothness which allow the adhesion effect to be exerted between the wall surfaces 22 and 24 is provided across the entire sipe 18 or 18A. However, the slit 20 is not necessarily provided across the entire sipe 18 or 18A. Besides the slit (the narrow portion) 20, the sipe 18 or 18A may include a portion having a wider width, an unsmoothed portion having the width W of 0.6 mm or less, and so on. Preferably, the sipe 18 or 18A chiefly includes the slit 20. More concretely, it is preferable that the slit 20 accounts for 50% or more (more preferably 70% or more) of the wall surface 22 (24). The same applies to the thin plate 54 of the sipe plate 52 or 52A.

In the embodiments above, the sipes 18 and 18A are closed sipes. However, the embodiments above may be applied also to a one-end open sipe that opens to the main groove at one end and terminates within the block at the other end, or a both-end open sipe that opens to the main grooves at the both ends.

The embodiments above have described a case where the sipes 18 or 18A are provided to the blocks 16 as the land portions. However, the land portion to which the sipe 18 or 18A as above is to be provided is not limited to a block and may be a rib continuing in the tire circumferential direction. The sipe configuration as above may be applied to all the land portions within a tread pattern or may be applied to only a part of the land portions within the tread pattern. For example, all the sipes within the tread pattern may have the slits or some of all the sipes may have the slits. In short, it is sufficient that at least one sipe including the slit is provided to at least one land portion within the tread pattern.

The collapse suppressing effect on the land portions is great in the embodiments above. Hence, the embodiments above are suitably applied to tires provided with a block-based tread pattern and capable of improving ice performance. That is to say, the embodiments above are suitably applied, for example, to snow tires (studless tires or winter tires). Use of tires is not particularly limited, and tires can be tires for passenger cars or heavy load tires for trucks and buses.

A dimension, such as a width, of the sipes of the embodiments above is a dimension in a regular state under no load when a tire is attached to a regular rim and inflated to a regular internal pressure. There are several standard systems including standards for tires and the regular rim is a rim specified for each tire according to a standard included in the corresponding standard system. For example, the regular rim is a standard rim according to JATMA, a “design rim” according to TRA, and a “measuring rim” according to ETRTO. Likewise, the regular internal pressure is an air pressure specified for each tire according to a standard included in the standard system. The regular internal pressure is a maximum air pressure according to JATMA, a maxima value set forth in the table of “tire load limits at various cold inflation pressures” according to TRA, and an “inflation pressure” according to ETRTO.

### Examples

In order to confirm the effects of the embodiments above, examples and comparative examples of heavy load pneumatic radial tires of a block pattern (size: 11R22.5 16 P.R.) were prepared. The sipe configurations of the respective tires are set forth in Table 1 below. The tire configurations are the same except for a width of sipes, a surface roughness of wall surfaces, and the presence or absence of concave grooves. Example 1 is a case having the sipe configuration without the concave grooves according to the first embodiment above shown in FIG. 3A. Examples 2 and 3 are cases having the sipe configuration with the concave grooves according to the second embodiment above shown in FIG. 7A. Comparative Examples 1 and 2 are cases having the sipe configuration without the concave grooves as with Example 1 and having a width of the sipe and a surface roughness different from those of Example 1.

The arithmetic roughness Ra set forth in Table 1 below was measured in accordance with JIS B0601:2013 using a stylus surface roughness meter “E-35A” available from Tokyo Seimitsu Co., Ltd.

Resistance to irregular wear was evaluated with the respective tires. Resistance to irregular wear was evaluated as follows. That is, the tire was attached to a rim (22.5×7.50) and inflated to an internal pressure of 700 kPa. The tire was then attached to a drive shaft of a heavy truck having a vehicle total weight of 20 tons. The truck was run on a paved dry road and a road covered with snow and ice for predetermined travel distances (about 7000 km and about 25000 km) under a load condition of 80% of a maximum load, and an amount of step-like wear, X (see FIG. 10), between one block and the following block in the tire circumferential direction was measured. In each travel distance, the resistance to irregular wear is represented as an index relative to a value of an amount of step-like wear in Comparative Example 1 which is taken as 100. The smaller the index number becomes, the more satisfactory is the resistance to irregular wear.

The results are set forth in Table 1 below. In comparison with Comparative Example 1 provided with wide sipes having rough surfaces, an amount of step-like wear is small and the resistance to irregular wear is markedly improved in Examples 1 through 3 provided with narrow sipes having smooth surfaces.

TABLE 1

| | Comparative | Comparative | | | |
|---|---|---|---|---|---|
| | Example 1 | Example 2 | Example 1 | Example 2 | Example 3 |
| Sipe width W(mm) | 0.8 | 0.3 | 0.3 | 0.3 | 0.3 |
| Sipe wall surface roughness | 2.6 | 2.6 | 1.0 | 1.0 | 1.5 |
| Ra (μm) | | | | | |
| Presence of concave grooves | None | None | None | Presence | Presence |
| Sipe plate surface roughness | 3.0 | 3.0 | 1.3 | 1.3 | 1.8 |
| Ra (μm) | | | | | |
| Amount of step-like wear | 100 | 76 | 48 | 14 | 24 |
| when travelled about 7000 | | | | | |
| km | | | | | |
| Amount of step-like wear | 100 | 75 | 66 | 22 | 31 |
| when travelled about 25000 | | | | | |
| km | | | | | |

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A pneumatic tire, comprising: a land portion provided to a tread; and a sipe provided to the land portion,
wherein:
the sipe comprises a slit having a width of 0.6 mm or less; and
the slit has an arithmetic mean roughness Ra of 1.6 μm or less on a pair of opposing wall surfaces.

2. A pneumatic tire, comprising: a land portion provided to a tread; and a sipe provided to the land portion,
wherein:
the sipe has a pair of opposing wall surfaces having surface smoothness and an interval that allow the wall surfaces to attract each other by a water film made of water entering into a space between the opposing wall surfaces.

3. The pneumatic tire according to claim 1, wherein:
at least one concave groove extending in a sipe depth direction is provided to at least one of a pair of the opposing wall surfaces of the sipe.

4. The pneumatic tire according to claim 3, wherein:
a width of the concave groove is equal to or less than a width of the sipe; and
a recess depth of the concave groove when viewed in a plane is equal to or less than the width of the sipe.

5. The pneumatic tire according to claim 2, wherein:
at least one concave groove extending in a sipe depth direction is provided to at least one of a pair of the opposing wall surfaces of the sipe.

6. The pneumatic tire according to claim 5, wherein:
a width of the concave groove is equal to or less than a width of the sipe; and
a recess depth of the concave groove when viewed in a plane is equal to or less than the width of the sipe.

7. The pneumatic tire according to claim 1, wherein:
the sipe essentially consists of the slit.

8. A molding die of a pneumatic tire, comprising:
a sipe plate to shape a sipe in a land portion provided to a tread,
wherein:
the sipe plate comprises a thin plate having a thickness of 0.6 mm or less; and
the thin plate has an arithmetic mean roughness Ra of 1.8 μm or less on a pair of side surfaces that shape a pair of opposing wall surfaces of the sipe.

9. The molding die of a pneumatic tire according to claim 8, wherein:
at least one convex ridge extending in a sipe depth direction is provided to at least one of a pair of the side surfaces of the sipe plate.

10. The molding die of a pneumatic tire according to claim 9, wherein:
a width of the convex ridge is equal to or less than a thickness of the sipe plate; and
a protrusion height of the convex ridge when viewed in a cross section is equal to or less than the thickness of the sipe plate.

11. The molding die of a pneumatic tire according to claim 8, wherein:
the sipe plate essentially consists of the thin plate.
